(19) United States
(12) Patent Application Publication
(10) Pub. No.: US 2025/0074805 A1
(43) Pub. Date: Mar. 6, 2025

(54) Submersible Bucket Filter System for Recirculating Deep Water Culture Systems

(71) Applicant: Michael Rodney Jackson, Burke, VA (US)

(72) Inventor: Michael Rodney Jackson, Burke, VA (US)

(21) Appl. No.: 18/815,607

(22) Filed: Aug. 26, 2024

Related U.S. Application Data
(60) Provisional application No. 63/579,077, filed on Aug. 28, 2023.

(51) Int. Cl. C02F 9/00; C02F 3/08

(52) U.S. Cl. CPC C02F 9/00; C02F 3/082

(57) ABSTRACT

The invention discloses a submersible bucket filter system for recirculating deep-water culture (RDWC) systems. The filter comprises a durable container with a submersible pump and filter media basket for mechanical, chemical, and biological filtration. The system functions independently or integrates into totes, ponds, or refugia. It offers two configurations: a weighted version for stability and a twist-lock quick-connect version for portability, ensuring the filter remains submerged even in low water. The system also adapts for pond use, supporting plant growth in aquatic settings.

### CROSS-REFERENCE TO RELATED APPLICATIONS

This application claims the benefit of U.S. Provisional Patent Application No. 63/579,077, filed on Aug. 28, 2023, titled “Recirculating Deep Water Culture Refugium with Virtual Digital Assistant for Aquaponics.”

### BACKGROUND OF THE INVENTION

### Field of the Invention

The present invention relates to hydroponic and aquaponic filtration systems, specifically a submersible bucket filter 10 designed for use in recirculating deep water culture (RDWC) systems. The invention can function independently as a standalone water filtration system or be integrated into a refugium 36, DWC tote 32, aquarium 50, or pond 34.

### Description of the Related Art

Hydroponics is a method of growing plants in a nutrient-rich water solution without the use of soil, recognized for its efficiency in producing high yields of plants while using significantly less water over time. In recirculating deep water culture (RDWC) systems, water is continuously cycled through the root zone of plants, providing them with the necessary nutrients and oxygen for optimal growth.

Traditional hydroponic setups can be complex, often requiring multiple components and intricate plumbing to ensure proper water circulation and filtration. These systems may also suffer from rapid water loss due to evaporation, plant uptake or equipment failure, leading to potential disruptions in plant growth.

The present invention addresses these issues by providing a robust, user-friendly solution that simplifies the operation of RDWC systems and provides a failsafe against catastrophic plant loss brought on by low water conditions. It also offers the flexibility to be adapted for use with RDWC totes, grow beds, refugia and ponds, where fish and plants coexist in a symbiotic environment.

### SUMMARY OF THE INVENTION

The present invention introduces a submersible bucket filter system 10 designed primarily for recirculating deep-water culture (RDWC) systems. The invention comprises a durable, watertight container 11 with an open top, constructed from high-density material such as polyethylene (HDPE), equipped with reinforced walls to maintain structural integrity under high pressure. The bucket filter features an integrated water pump 28, media basket 16 for biological, chemical, and mechanical filtration and a sturdy nylon carrying strap 12 with ergonomic hand grip 14, connected to opposite sides of the bucket filter compartment 11 for ease of handling and transportation.

This system is designed to function independently, with the return hose 20 routed back into the intake side of a RDWC tote, enabling biological, chemical, and mechanical filtration while providing continuous water recirculation within the system. This self-contained configuration simplifies setup and operation, making the system highly accessible for users.

The system offers two primary configurations for securing the filter housing to the floor of a larger container such as a RDWC tote 32, refugium 36, or pond 34:

Weighted Configuration 10: The filter container features a weighted bottom 38, achieved through integrated heavy materials 40 to ensure stability within the aquatic environment, especially when water levels are low. This setup ensures that the bucket filter 10 remains in contact with the floor 48, even when empty and submerged in water, preventing buoyancy that could cause the container to float and disrupt water circulation.

Twist-Lock Quick-Connect Configuration 15: Alternatively, the filter container 11 can be connected directly to the floor of a larger container 48 using a twist-lock quick-connect mechanism 42. This configuration involves placing the container 11 in position and twisting it to securely attach the base of the filter to the tote floor. This version does not require added weights, making the system lighter and easier to handle, which is advantageous for users who can't lift heavy objects.

In the hydroponic configuration, the return hose 20 is routed through to the other end of the tote 32, up through the top of the lid, and back down into the tote 32, allowing for continuous water recirculation within the tote 32. At the end of the return hose 20, a plastic connector is used. A sponge filter medium is placed over this connector, serving as both a filtration medium and a sound baffle, reducing splashing noises and making the system quieter. The sponge also acts as an excellent biological and mechanical filtration media, providing a surface for beneficial bacteria to colonize.

In the aquaponics configuration, the return hose 20 is routed into an adjacent fish tank or aquarium 50 rather than back into the tote 32. The tote 32 may then be properly considered to be a refugium 36. The intake hose 20 is connected to an overflow filter that uses a gravity siphon to pull water from the aquarium 50 back into the refugium In this setup, a filter sock can be placed underneath the intake to filter particulates coming from the aquarium 50, ensuring that only clean water is recirculated.

Pond Configuration: The submersible recirculating bucket filter system 10 can also be adapted for use in ponds 34. This configuration involves placing the bucket filter 10 directly into a pond 35 or as a component within a RDWC tote 34. As a standalone filtration system, the filter bucket 10 can be placed in one end of a pond, and the return hose 20 with spray nozzle 21 sent to the opposite end of the pond 34, which may include additional water features such as a fountain or waterfall 56.

When used as a component in a RDWC refugium 36, an intake opening 37 is added to the wall of the refugium, and the return hose of the bucket filter is routed through the opposite wall of the refugium back into the pond. As long as the top of the RDWC refugium 36 remains above the waterline of the pond, water will continue to recirculate normally inside the tote, allowing for the cultivation of plants 22 directly within the pond environment 34. The submersible bucket filter 10 continues to recirculate and filter the water within the system, promoting healthy plant growth in the aquatic environment.

### BRIEF DESCRIPTION OF THE DRAWINGS

FIG. 1: A cross-sectional view of the submersible bucket filter unit 10, showing its structural components, including the container 11 with open top 13, media basket 16, filter media 24/26, water pump 28, return hose 20, pebble substrate 18 and weighted plates 40 embedded in a sealed bottom 38. Shows the water level 17 with arrows indicating how water flows through the system.

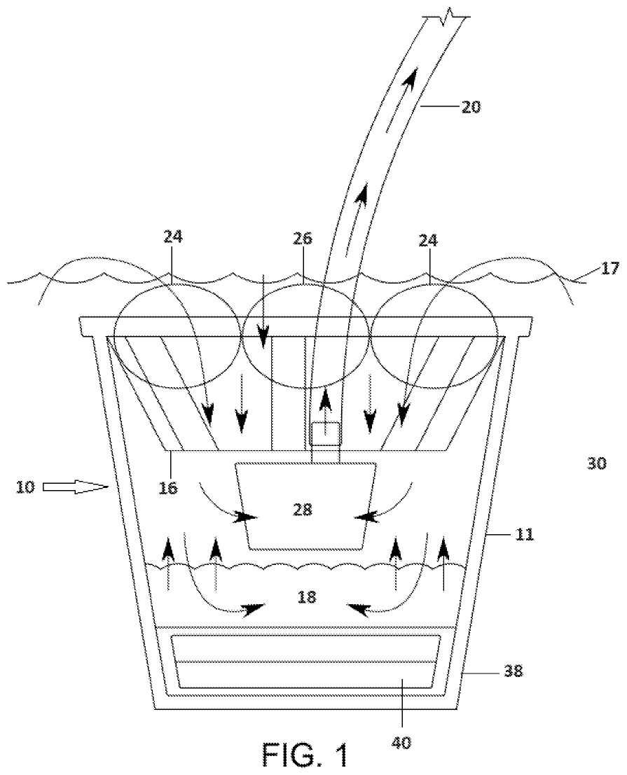

FIG. 2: A detailed view of the media basket 16 detailing the lip cover 60 and return hose 20 passthrough.

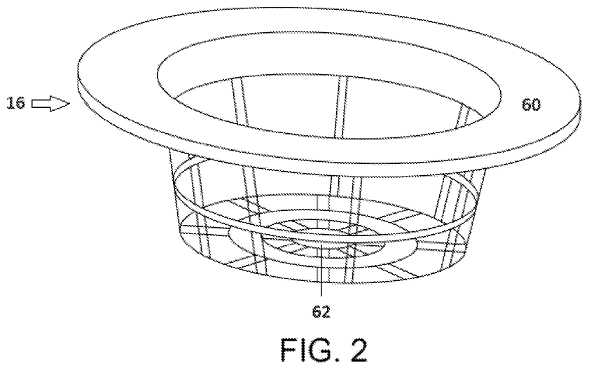

FIG. 3: A detailed view of the base of the bucket filter container housing with a twist-lock quick-connect mechanism 15 for easy attachment and detachment. Details a curved rail system 42 to fix the bucket securely in place when submerged.

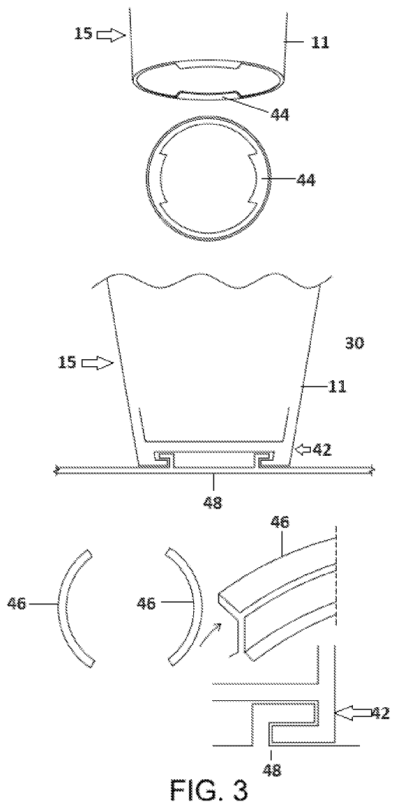

FIG. 4: Includes 3 separate schematics. The top schematic illustrates the filter's operation in a hydroponics system, showing the bucket filter 10 inside a RDWC tote 32, recirculating water through the root system 14 of a hydrophilic plant 22. The plant is sitting in a grow bed or pot 23 containing clay pebbles or similar substrate. Underneath is a schematic of the filter's optional integration into an aquaponics system 36, showing the flow of water between an aquarium 50 containing fish 51 and DWC system equipped with a bucket filter 10. The bottom schematic illustrates the pond configuration, showing the placement of the bucket filter 10 directly in the pond 34, with the return hose 20 routed to a waterfall feature 21.

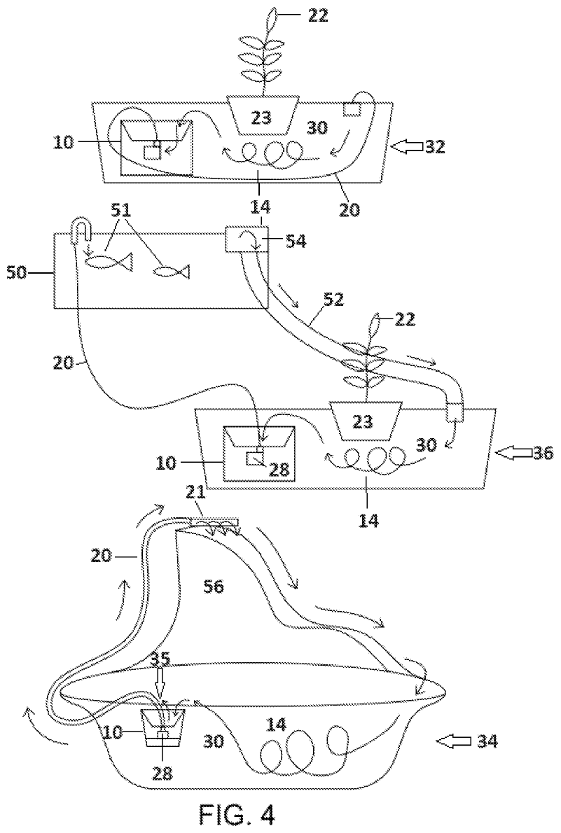

FIG. 5: Includes 2 separate schematics. The top schematic shows a bucket filter 10 operating inside a RDWC refugium while partially submerged within a pond, with the intake on one side 37, and the return hose routed out of the opposite side 39.

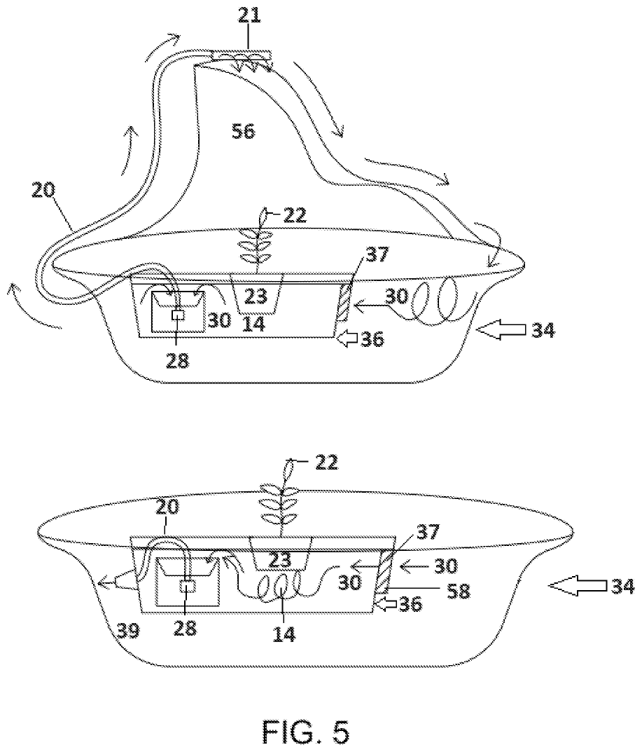

FIG. 6: Shows angled view of bucket filter container 11 with weighted bottom 38 and reinforced nylon straps 12 with ergonomic handle 14.

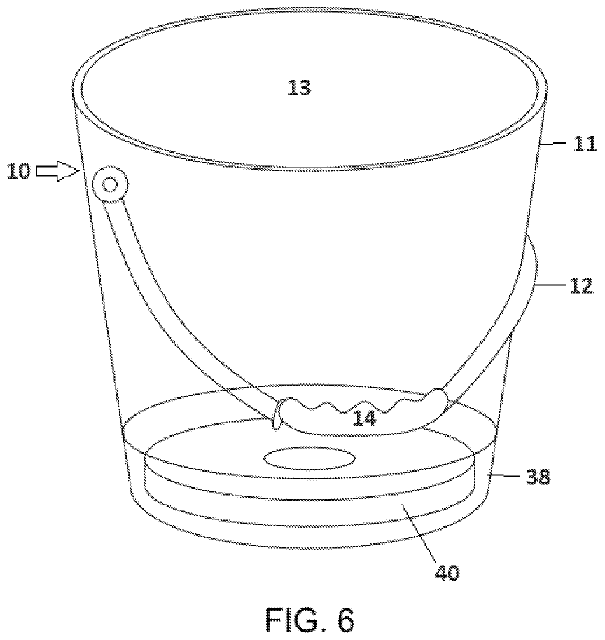

### DETAILED DESCRIPTION OF THE INVENTION

The submersible bucket filter system 10 is envisioned as a durable, watertight container 11, with an open top, preferably made of high-density polyethylene (HDPE) or polypropylene (PP), strong enough to prevent bowing under pressure. The container 11 is designed to withstand the forces exerted by large volumes of water, maintaining its shape and stability over time. A sturdy nylon strap 12 with hand grip 14 is integrated into opposite sides of the bucket filter compartment, facilitating easy lifting and carrying of the filter, especially during setup, maintenance, or when relocating the unit.

In its primary configuration as part of a hydroponic system, the filter operates as a self-contained unit. The filter draws water from the root zone of the plants 14, passing it through a media basket 16 housing biological, chemical, and mechanical filtration materials. The water circulates around the main chamber containing a substrate 18 where it is pumped out of the container 11 and recirculated back into the opposite side of a tote, refugium, or pond through a return hose 20. The continuous flow of nutrient rich water through the root zone 14 of a RDWC system helps to ensure sufficient nutrient delivery to the plants 22.

The media basket 16 is designed for biological, chemical, and mechanical filtration. Bags of filter media 24 such as ceramic noodles, or bio-balls provide the surface area necessary for sufficient bacteria growth. Sponge filter pads or filter floss may be added to assist in the removal of large debris and particulate matter from the water. Bags of chemical filter media 26 such as peat moss or activated carbon can be added to remove impurities and improve growing conditions.

A water pump 28 is situated on top of substrate 18 laying at the bottom of the container, drawing water 30 through the filtration media and returning it to the main aquatic environment.

The submersible bucket filter 10 is designed to limit water loss within the system by automatically stopping the recirculation of water once levels drop below the top of the container 11. Should water levels drop below the top of the filter bucket 10, the container 11 empties out and flow to the water pump is cut off, halting recirculation in the system and conserving the remaining water inside the DWC system, tote 32, pond 34, or refugium 36.

The filter is envisioned with two versions for securing it within a body of water 30:

Weighted Version: As water levels drop below the top of the container 11, the flow of water is cut off and the remaining water is pumped out of the bucket, increasing buoyancy. The submersible bucket filter 10 may include a weighted bottom 38 to ensure stability, even in low-water conditions. The weighted bottom can be achieved by embedding heavy materials like metal plates 40, concrete, or stone into the bottom of the container. This configuration is ideal for users who require a stable filter but prefer it not be fixed to the floor.

Twist-Lock Quick-Connect Version: In this alternative version 15, the filter container 11 is envisioned to connect directly to the floor of a plastic tote, tank or pond using a twist-lock quick-connect rail mechanism 42. The container 11 includes guide rails 44 on opposite sides of the bottom. The filter bucket 15 is placed in the unlocked or open position and then rotated approximately ninety degrees to securely connect to curved rails 46, embedded or otherwise attached to the floor 48. Continued rotation or rotating the unit in the opposite direction releases the bucket from the floor. This configuration fixes the container to the floor 48, even in low water conditions and eliminates the need for embedded weights, making the system lighter and easier to handle. This is particularly beneficial for users who have difficulty lifting heavy weights.

Hydroponics Configuration: In the hydroponic configuration, the filter is placed on one end of a DWC grow bed or tote 32 and the return hose 20 is routed through the system, up through the top of the lid and back down into the tote, allowing for continuous water recirculation through the root zone 14 of the system. The return hose can be fitted with a connector at the end, covered with a sponge filter medium to filter particulates and add biological filtration capacity to the system. This sponge not only provides excellent biological and mechanical filtration but also acts as a sound baffle, reducing splashing noises inside the tote.

While the submersible bucket filter system 10 excels at recirculating water in a hydroponic system, it also offers additional functionality when integrated into a refugium 36 or connected to a larger aquatic system such as an aquarium 50 or pond In these alternate configurations, the bucket filter 10 can be one component in a larger RDWC system, continuously delivering nutrient rich water to plants and contributing to the overall health and stability of the environment. This versatility is key to its wide application across different types of growing systems.

Aquaponics Configuration: In the aquaponics configuration, the return hose 20 is routed into an adjacent aquarium 50 instead of being sent directly back to a grow bed or tote 32. A spa flexible, PVC hose 52 is connected to an overflow filter 54 that uses gravity to siphon water from the aquarium back into a grow bed or RDWC tote 32. A filter sock can be added to filter particulates coming from the aquarium, helping to ensure only clean water is recirculated back to the plant root zone.

Pond Configuration: The system is also adaptable for use in pond environments. In this configuration, the submersible bucket filter 10 can be placed directly into a pond with the return hose 20 routed to the opposite end of the pond 34 or to a waterfall to produce continuous recirculation and filtration of water. Alternatively, the bucket filter 10 can be placed inside a DWC tote 32 and then placed into a pond. Note: when connected to a second, larger body of water like an aquarium 50 or pond 34, a RDWC tote 32 is redefined as a refugium 36. An intake opening 58 covered by sponge filter material is included on one the wall of the refugium 36, and the return hose 20 of the bucket filter 10 is routed through the opposite wall of the refugium 36. As long as the water level remains above the top of the submersible filter bucket 10, the system will continue to recirculate water while providing ideal conditions for hydrophilic plants to thrive within the pond environment.

The filter media basket 16 includes an opening 62 large enough to accommodate a return hose 20 and features a lip cover 60 that is designed to fit securely over the edge of the filter container 11. The lip cover 60 acts as a flow regulator, ensuring that water flow is evenly distributed over the filter media thereby enhancing the system's efficiency; and it contributes to the overall structural integrity of the filter system by holding the upper edge of the filter in place. The lip cover 60 is made from a durable, water-resistant material that is both flexible and resilient, allowing it to maintain its shape and function over extended periods.

A single submersible bucket filter 10 can be used to power the recirculation of filtered water between multiple totes connected in a series. The filter is placed in the tote at the end of a series of totes (2 or more), with the return hose directed into the intake of the first tote in the series. Hoses can be connected between totes below the waterline or above the waterline using a gravity siphon to move the water from the first tote to the second, then from the third to the fourth (etc.) in the series until it reaches the filter bucket in the final tote and is recirculated once back to the first tote in the series.

1. A submersible bucket filter system 10, comprising a watertight bucket 11 with an open top 13, reinforced carrying strap 12 and ergonomic handle 14, constructed from molded materials such as high-density polyethylene (HDPE), including a weighted bottom to prevent buoyancy and maintain stability in rapidly flowing or low water conditions.

2. The submersible bucket filter system 10 of claim 1, further comprising a removable media basket 16 designed to house various biological, chemical, and mechanical filter media with access for a return hose 20 connected to a submersible water pump 28 and a quick-connect twist-lock mechanism 42 for attaching the bottom of a bucket filter to the floor of another container of water such as a tote 32 or pond 34.

3. The submersible bucket filter system 10 of claim 1, further comprising a weighted bottom 38 that allows the filter to sit securely on the floor of a container of water such as a tote 32, refugium 36, fish tank 50, or pond 34.

4. The submersible bucket filter system 15 of claim 1, further comprising a molded plastic guide rails 46 designed to allow the filter to easily connect 42 to the floor of another container 48 such as a tote 32, refugium 36, fish tank 50, or pond 34.

5. The submersible bucket filter system 10 of claim 1, wherein the system includes a media basket 16 with an opening at the bottom 62 to accommodate a return hose 20 and that is removable for easy maintenance and cleaning of the filtration media.

6. The submersible bucket filter system of claim 1, further comprising a media basket 16 with a wide lip cover 60 designed to fit securely over the top edge of the bucket filter, wherein the lip cover 60 acts as a flow regulator to evenly distribute water over the top of the filter into the media compartments and contributes to the structural integrity of the filter system.
